(19) United States
(12) Patent Application Publication
(10) Pub. No.: US 2026/0370167 A1
(43) Pub. Date: Nov. 19, 2026

(54) CURRENT HARMONIC DISTURBANCE SUPPRESSING METHOD OF PERMANENT MAGNET SYNCHRONOUS MOTOR AND MOTOR SYSTEM

(71) Applicant: Changchun Institute of Optics, Fine Mechanics and Physics, Chinese Academy of Sciences, Changchun (CN)

(72) Inventors: Yongting DENG, Changchun (CN); Jianli WANG, Changchun (CN); Chuanlong ZHAI, Changchun (CN); Xiufeng LIU, Changchun (CN); Jing LIU, Changchun (CN); Yang LIU, Changchun (CN); Meng SHAO, Changchun (CN); Bin ZHANG, Changchun (CN); Shuai WANG, Changchun (CN); Xiaoxia YANG, Changchun (CN)

(73) Assignee: Changchun Institute of Optics, Fine Mechanics and Physics, Chinese Academy of Sciences, Changchun (CN)

(21) Appl. No.: 19/370,651

(22) Filed: Oct. 27, 2025

Related U.S. Application Data
(63) Continuation of application No. PCT/CN2025/117617, filed on Aug. 28, 2025.

(30) Foreign Application Priority Data
May 16, 2025 (CN) 2025106333942

(51) Int. Cl. H02P 21/13; H02P 21/14; H02P 21/18; H02P 21/22

(52) U.S. Cl. CPC H02P 21/13; H02P 21/141; H02P 21/18; H02P 21/22; H02P 2207/055

(57) ABSTRACT

This disclosure relates to the technical field of motor control, and particularly provides a current harmonic disturbance suppressing method of a permanent magnet synchronous motor and a motor system. Firstly, a mathematical model of a permanent magnet synchronous motor considering harmonic disturbance in a d-q axis of a synchronous rotating coordinate system is constructed, which provides theoretical basis for subsequent control strategy design. Based on this, an improved resonant controller is set up and embedded in an extended state observer to realize comprehensive estimation of aperiodic disturbance and periodic harmonic disturbance in the d-q axis. Finally, an enhanced active disturbances rejection controller for current loop of the improved resonant controller-based extended state observer is constructed to eliminate unexpected peaks and realize comprehensive suppression of aperiodic disturbance and periodic disturbance.

### CROSS-REFERENCE TO RELATED APPLICATIONS

The application claims priority to Chinese patent application No. 2025106333942, filed on May 16, 2025, the entire contents of which are incorporated herein by reference.

### TECHNICAL FIELD

This disclosure belongs to the technical field of motor control, and particularly relates to a current harmonic disturbance suppressing method of a permanent magnet synchronous motor and a motor system.

### BACKGROUND

Permanent magnet synchronous motors have been widely used in electric vehicles and precision equipment due to their high reliability, high efficiency, and high power density. However, aperiodic disturbance and periodic harmonic disturbance faced during motor operation seriously affect system performance and control accuracy. Active Disturbance Rejection Control (ADRC), as a control method that does not depend on precise models, has shown a wide application prospect in permanent magnet synchronous motor control due to its ability of efficient estimation and compensation on system disturbance. An Extended State Observer (ESO) is a core component of the ADRC, and can estimate the state and disturbance of a system, thus effectively improving the anti-disturbance performance of the system. However, due to a limited bandwidth, it is difficult for a traditional ESO to accurately estimate the disturbance and effectively suppress the measurement noise simultaneously, thus limiting the further improvement of system performance. In addition, the traditional resonant controller-based ADRC algorithm may also cause unexpected peak problems and amplify noises in this frequency band, thus affecting system stability.

### SUMMARY

In view of this, this disclosure aims to provide a current harmonic disturbance suppressing method of a permanent magnet synchronous motor, designs an improved resonant controller, and embeds the improved resonant controller into an extended state observer to perform disturbance estimation, which effectively suppresses aperiodic disturbance and periodic harmonic disturbance in motor operation, eliminates unexpected peaks, and improves the performance of the motor system.

To achieve the above objective, this disclosure makes use of the following technical solution:

An aspect of this disclosure provides a current harmonic disturbance suppressing method of a permanent magnet synchronous motor, including:
constructing a current loop mathematical model of a permanent magnet synchronous motor considering total disturbance, and defining d-q axis total disturbance as an extended state of a motor system, where the current loop mathematical model of a permanent magnet synchronous motor considering total disturbance is as follows:

$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {i}_{sq} = {γ}_{0} {u}_{sq}^{*} + {f}_{sq 0} + {f}_{sq}^{t}\end{matrix} ;$$

where t represents time, i_{sd} represents a d-axis stator current, i_{sq} represents a q-axis stator current, γ₀ represents current control gain, γ₀=1/Lₛ₀, Lₛ₀ represents nominal inductance of a motor,

$${u}_{sd}^{*}$$

represents a d-axis stator reference voltage,

$${u}_{sq}^{*}$$

represents a q-axis stator reference voltage, f_{sd0} represents known d-axis disturbance, f_{sq0} represents known q-axis disturbance,

$${f}_{sd}^{t}$$

represents d-axis total disturbance, and

$${f}_{sq}^{t}$$

represents q-axis total disturbance;
designing an improved resonant controller, where the improved resonant controller G_{IRSC}(s) for any frequency harmonic is as follows:

$${G}_{IRSC} ( s ) = \frac{{k}_{r} {ω}_{c} {Δ}_{1}}{{s}^{2} + 2 {ω}_{c} s + {ω}_{h}^{2}}$$

where kᵣ represents resonance gain, ω_{c} represents a resonance bandwidth, ωₕ represents a resonance frequency,

$${Δ}_{1} = {s}^{2} + 2 {ω}_{o} s + {ω}_{o}^{2} ,$$

s represents a Laplace complex frequency variable, and ωₒ represents a bandwidth of an extended state observer;
embedding the improved resonant controller into an extended state observer to estimate the total disturbance; and
introducing the total disturbance estimate into a control terminal as a feedforward signal, and designing a control law to compensate for the total disturbance in the current loop mathematical model of the permanent magnet synchronous motor.

Preferably, the total disturbance includes aperiodic disturbance and periodic harmonic disturbance.

Preferably, a calculation equation of d-q axis periodic harmonic disturbance of the current loop is as follows:

f_{s_p}=N[Δuₕₐᵣ+nₚωₘψₕₐᵣ];
where f_{s_p}=[f_{sd_p} f_{sq_p}]^{T}, f_{s_p} represents the d-q axis harmonic disturbance, f_{sd_p} represents d-axis harmonic disturbance, f_{sq_p} represents q-axis harmonic disturbance

$${Δ u}_{har} = [ \begin{matrix}{Δ u}_{d \_ har} \\ {Δ u}_{q \_ har}\end{matrix} ] ,$$

Δuₕₐᵣ represents d-q axis voltage harmonics caused by inverter dead-time effect, Δu_{d_har} represents d-axis voltage harmonics caused by inverter dead-time effect, Δu_{q_har} represents q-axis voltage harmonics caused by inverter dead-time effect,

$${ψ}_{har} = [ \begin{matrix}{ψ}_{q \_ har} \\ - {ψ}_{d \_ har}\end{matrix} ] ,$$

ψₕₐᵣ represents d-q axis permanent magnet flux harmonics, ψ_{d_har} represents d-axis flux harmonics, ψ_{q_har} represents q-axis flux harmonics, N=[[1/(ΔL_{sd}+Lₛ₀)0][0 1/(ΔL_{sq}+Lₛ₀)]]^{T}, nₚ represents the number of pole pairs of the motor, ωₘ represents a mechanical angular velocity of the motor, ΔL_{sd}=L_{sd}−L_{sd0}, ΔL_{sd} represents an error between d-axis actual inductance L_{sd} and nominal d-axis inductance L_{sd0}, ΔL_{sq}=L_{sq}−L_{sq0}, ΔL_{sq} represents an error between q-axis actual inductance L_{sq} and nominal q-axis inductance L_{sq0}, and a surface-mounted permanent magnet synchronous motor meets ΔL_{sd}=L_{sq0}=Lₛ₀; and
a calculation equation of d-q axis aperiodic disturbance of the current loop is as follows:

$$\{ \begin{matrix}{f}_{sd \_ ap} = \frac{Δ {L}_{sd} {R}_{s 0} - {L}_{s 0} Δ {R}_{s}}{{L}_{s 0} ( Δ {L}_{sd} + {L}_{s 0} )} {i}_{sd} + \frac{{n}_{p} {ω}_{m} ( Δ {L}_{sq} - Δ {L}_{sd} )}{Δ {L}_{sd} + {L}_{s 0}} {i}_{sq} \\ - \frac{Δ {L}_{sd}}{{L}_{s 0} ( {Δ L}_{sd} + {L}_{s 0} )} {u}_{sd} + {δ}_{sd} \\ {f}_{sq \_ ap} = \frac{Δ {L}_{sq} {R}_{s 0} - {L}_{s 0} Δ {R}_{s}}{{L}_{s 0} ( Δ {L}_{sq} + {L}_{s 0} )} {i}_{sq} - \frac{{n}_{p} {ω}_{m} ( Δ {L}_{sd} - Δ {L}_{sq} )}{Δ {L}_{sq} + {L}_{s 0}} {i}_{sd} \\ - \frac{Δ {L}_{sd}}{{L}_{s 0} ( {ΔL}_{sd} + {L}_{s 0} )} {u}_{sd} + \frac{- {L}_{s 0} {Δψ}_{f} + {Δ L}_{sq} {ψ}_{{f}_{0}}}{{L}_{s 0} ( {Δ L}_{sq} + {L}_{s 0} )} {n}_{p} {ω}_{m} + {δ}_{sq}\end{matrix} ;$$

where f_{sd_ap} represents d-axis aperiodic disturbance, f_{sq_ap} represents q-axis aperiodic disturbance, ΔRₛ=Rₛ−Rₛ₀, ΔRₛ represents an error between actual resistance Rₛ and nominal resistance Rₛ_{₀}, δ_{sd} represents d-axis uncertainty disturbance, and δ_{sq} represents q-axis uncertainty disturbance.

Preferably, defining the d-q axis total disturbance as the extended state of the motor system to obtain an extended state system is as follows:

$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {f}_{sd}^{t} = {𝒩}_{sd}\end{matrix} ;$$

$$\{ \begin{matrix}\frac{d}{dt} {i}_{sq} = {γ}_{0} {u}_{sq}^{*} + {f}_{sq 0} + {f}_{sq}^{t} \\ \frac{d}{dt} {f}_{sq}^{t} = {𝒩}_{sq}\end{matrix} ; and$$

where [symbol] _{sd} is a derivative of the d-axis total disturbance, and [symbol] _{sq} is a derivative of the q-axis total disturbance.

Preferably, when suppressing multi-frequency harmonic disturbance, an expression of the improved resonant controller G_{IRSC}_{ₛ}(s) is as follows:

$${G}_{{IRSC}_{s}} ( s ) = \frac{{k}_{r 1} {ω}_{c 1} {Δ}_{1}}{{s}^{2} + 2 {ω}_{c 1} s + {ω}_{h 1}^{2}} + \frac{{k}_{r 2} {ω}_{c 2} {Δ}_{1}}{{s}^{2} + 2 {ω}_{c 2} s + {ω}_{h 2}^{2}} + … + \frac{{k}_{rn} {ω}_{cn} {Δ}_{1}}{{s}^{2} + 2 {ω}_{cn} s + {ω}_{hn}^{2}} ;$$

where kᵣ₁, kᵣ₂, . . . , kᵣₙ represent resonance gains of different frequencies, ω_{c1}, ω_{c2}, . . . , ω_{cn} represent resonance bandwidths of different frequencies, and ωₕ₁, ωₕ₂ . . . , ωₕₙ represent resonance frequencies of different frequencies.

Preferably, when 6th harmonic disturbance and 12th harmonic disturbance are suppressed, ωₕ₁=6nₚωₘ, and ωₕ₂=12nₚωₘ.

Preferably, embedding the improved resonant controller into the extended state observer, improved d-axis and q-axis resonant—extended state observers are obtained as follows:

$$\{ \begin{matrix}\frac{d}{dt} {\hat{l}}_{sd} = {γ}_{0} {u}_{sd}^{*} + {f}_{sd 0} + \hat{{f}_{sd}^{t}} + {λ}_{1} ( {i}_{sd} - {\hat{l}}_{sd} ) \\ {\hat{f}}_{sd}^{t} = {\hat{f}}_{sd \_ ap}^{t} + {\hat{f}}_{sd \_ p}^{t} , {\hat{f}}_{sd \_ p}^{t} = {κ}_{2} + {κ}_{4} \\ {ϑ}_{sd} = ( {i}_{sd} - {\hat{l}}_{sd} ) + \frac{d}{dt} ( {i}_{sd} - {\hat{l}}_{sd} ) + \int ( {i}_{sd} - {\hat{l}}_{sd} ) dt \\ \frac{d}{dt} {κ}_{1} = {κ}_{2} , \frac{d}{dt} {κ}_{3} = {κ}_{4} \\ \frac{d}{dt} {κ}_{2} = - {ω}_{h 1}^{2} {κ}_{1} + {λ}_{2} {k}_{r 1} {ω}_{c 1} {ϑ}_{sd} - 2 {ω}_{c 1} {κ}_{2} \\ \frac{d}{dt} {\hat{f}}_{sd \_ ap}^{t} = {λ}_{2} ( {i}_{sd} - {\hat{l}}_{sd} ) \\ \frac{d}{dt} {κ}_{4} = - {ω}_{h 2}^{2} {κ}_{3} + {λ}_{2} {k}_{r 2} {ω}_{c 2} {ϑ}_{sd} - 2 {ω}_{c 2} {κ}_{4}\end{matrix}$$

$$\{ \begin{matrix}\frac{d}{dt} {\hat{l}}_{sq} = {γ}_{0} {u}_{sq}^{*} + {f}_{sq 0} + \hat{{f}_{sq}^{t}} + {λ}_{1} ( {i}_{sq} - {\hat{l}}_{sq} ) \\ {\hat{f}}_{sq}^{t} = {\hat{f}}_{sq \_ ap}^{t} + {\hat{f}}_{sq \_ p}^{t} , {\hat{f}}_{sq \_ p}^{t} = {κ}_{2} + {κ}_{4} \\ {ϑ}_{sq} = ( {i}_{sq} - {\hat{l}}_{sq} ) + \frac{d}{dt} ( {i}_{sq} - {\hat{l}}_{sq} ) + \int ( {i}_{sq} - {\hat{l}}_{sq} ) dt \\ \frac{d}{dt} {κ}_{1} = {κ}_{2} , \frac{d}{dt} {κ}_{3} = {κ}_{4} \\ \frac{d}{dt} {κ}_{2} = - {ω}_{h 1}^{2} {κ}_{1} + {λ}_{2} {k}_{r 1} {ω}_{c 1} {ϑ}_{sd} - 2 {ω}_{c 1} {κ}_{2} \\ \frac{d}{dt} {\hat{f}}_{sq \_ ap}^{t} = {λ}_{2} ( {i}_{sq} - {\hat{l}}_{sq} ) \\ \frac{d}{dt} {κ}_{4} = - {ω}_{h 2}^{2} {κ}_{3} + {λ}_{2} {k}_{r 2} {ω}_{c 2} {ϑ}_{sd} - 2 {ω}_{c 2} {κ}_{4}\end{matrix} ;$$

where \hat{l}_{sd} represents a d-axis stator current estimate, \hat{l}_{sq} represents a q-axis stator current estimate,

$$\hat{{f}_{sd}^{t}}$$

represents a d-axis total disturbance estimate,

$$\hat{{f}_{sq}^{t}}$$

represents a q-axis total disturbance estimate,

$${\hat{f}}_{sd \_ ap}^{t}$$

represents a d-axis aperiodic disturbance estimate,

$${\hat{f}}_{sq \_ ap}^{t}$$

represents a q-axis aperiodic disturbance estimate

$${\hat{f}}_{sd \_ p}^{t}$$

represents a d-axis harmonic disturbance estimate,

$${\hat{f}}_{sq \_ p}^{t}$$

represents a q-axis harmonic disturbance estimate, κ₁, κ₂, κ₃, and κ₄ represent state variables of the improved resonant controller, λ₁ and λ₂ represent gain coefficients of the extended state observer, and ϑ_{sd} and ϑ_{sq} represent intermediate variables.

Preferably, the control law is as follows:

$$\{ \begin{matrix}{u}_{sd}^{*} = \frac{{i}_{sd}^{*} + {u}_{d 0} - {f}_{sd 0} - {\hat{f}}_{sd}^{t}}{{γ}_{0}} \\ {u}_{s q}^{*} = \frac{{i}_{sq}^{*} + {u}_{q 0} - {f}_{sq 0} - {\hat{f}}_{sq}^{t}}{{γ}_{0}}\end{matrix} ;$$

where

$${u}_{sd}^{*}$$

represents the d-axis stator reference voltage,

$${u}_{sq}^{*}$$

represents the q-axis stator reference voltage,

$${i}_{sd}^{*}$$

represents a d-axis reference current

$${i}_{sq}^{*}$$

represents a q-axis reference current, f_{sd0} represents a constant for compensating for the known d-axis disturbance, f_{sq0} represents a constant for compensating for the known q-axis disturbance,

$${u}_{d 0} = {k}_{pd} ( {i}_{sd}^{*} - {\hat{l}}_{sd} ) ,$$

k_{pd} represents d-axis current loop controller gain,

$${u}_{q 0} = {k}_{pq} ( {i}_{sq}^{*} - {\hat{l}}_{sq} ) ,$$

and k_{pq} represents q-axis current loop controller gain.

Another aspect of this disclosure provides a motor system, adopting the current harmonic disturbance suppressing method of a permanent magnet synchronous motor.

Compared with the prior art, this disclosure can achieve the following beneficial effects:

According to this disclosure, by constructing an extended state observer containing an improved resonant controller, the d-q axis aperiodic disturbance and harmonic disturbance are estimated and suppressed; and by optimizing the resonance characteristics and the observer structure, the ability of suppressing harmonic disturbance is enhanced, and meanwhile, unexpected peaks near the resonance frequency is effectively eliminated. Compare with traditional ADRC and traditional resonant ADRC, the method of this disclosure has obvious effect of suppressing current harmonic, and avoids risks of amplifying noise near the resonance frequency and affecting the stability of the system, thereby obviously improving harmonic suppression capability and running stability of the system.

The method of this disclosure can effectively resist adverse effects caused by parameter changes under complex working conditions, ensure that the system has strong anti-disturbance performance and reliability, and can maintain excellent control performance under system parameter changes. Compared with traditional control methods, the enhanced ADRC method has obvious advantages in harmonic suppression, system stability, parameter robustness, and the like.

### BRIEF DESCRIPTION OF THE DRAWINGS

The accompanying drawings which constitute a part of this disclosure provide further understanding of this disclosure. The schematic embodiments of this disclosure and description thereof are intended to explain this disclosure and are not intended to constitute an improper limit to this disclosure. In the accompanying drawings:

FIG. 1 is a structural block diagram of a permanent magnet synchronous motor control system to which a current harmonic disturbance suppressing method of the permanent magnet synchronous motor provided by an embodiment of this disclosure is applied;

FIG. 2 is a current harmonic disturbance suppressing method of a permanent magnet synchronous motor provided by an embodiment of this disclosure;

FIG. 3 is a structural block diagram of an enhanced ADRC of an improved resonant controller-based extended state observer provided by an embodiment of this disclosure;

FIG. 4 is a bode diagram of a traditional resonant controller under different ω_{c} conditions provided by an embodiment of this disclosure;

FIG. 5 is a bode diagram of a traditional resonant controller under different kᵣ conditions provided by an embodiment of this disclosure;

FIG. 6 is a bode diagram of an improved resonant controller under different ω_{c} conditions provided by an embodiment of this disclosure;

FIG. 7 is a bode diagram of an improved resonant controller under different ω_{c} conditions provided by an embodiment of this disclosure;

FIG. 8 is a bode diagram of a transfer function between a disturbance estimation error and an actual disturbance under different observers provided by an embodiment of this disclosure;

FIG. 9 is a bode diagram of a transfer function between a closed-loop system output and an actual disturbance under different ADRC algorithms provided by an embodiment of this disclosure;

FIG. 10 shows d-q axis and phase current waveforms of a traditional ADRC with a rotating speed of 150 r/min and a load of 3 N·m provided by an embodiment of this disclosure;

FIG. 11 shows d-q axis and phase current waveforms of a traditional resonant ADRC with a rotating speed of 150 r/min and a load of 3 N·m provided by an embodiment of this disclosure;

FIG. 12 shows d-q axis and phase current waveforms of an enhanced ADRC with a rotating speed of 150 r/min and a load of 3 N·m provided by an embodiment of this disclosure;

FIG. 13 shows d-q axis current waveforms of inductance mismatch with a rotating speed of 150 r/min and a load of 6 N·m provided by an embodiment of this disclosure;

FIG. 14 shows d-q axis current waveforms of resistance mismatch with a rotating speed of 150 r/min and a load of 6 N·m provided by an embodiment of this disclosure; and

FIG. 15 shows d-q axis current waveforms of flux linkage mismatch with a rotating speed of 150 r/min and a load of 6 N·m provided by an embodiment of this disclosure.

### DETAILED DESCRIPTION OF THE EMBODIMENTS

To make the objectives, technical solutions, and advantages of this disclosure clearer, the following further describes this disclosure in detail with reference to the accompanying drawings and specific embodiments. It should be understood that the specific embodiments described herein are merely intended to explain this disclosure, but do not pose a limitation to this disclosure. Associated similar element reference numerals are used for similar elements in different implementations. In the following implementations, many details are described such that this disclosure may be better understood. However, it may be effortlessly appreciated by persons skilled in the art that some of the features may be omitted, or may be substituted by other elements, materials, and methods in different cases. In certain cases, some operations involved in this disclosure are not displayed or described in the specification, which is to prevent a core part of the disclosure from being obscured by too much description. Moreover, for persons skilled in the art, the detailed description of the involved operations is not necessary, and the involved operations can be thoroughly understood according to the description in the specification and general technical knowledge in the art.

It should be noted that the embodiments of this disclosure and the features in the embodiments can be combined with each other to form various implementations in case of no conflict. In addition, the steps or actions in the method description may also be exchanged or adjusted in order in a way that is obvious to persons skilled in the art. Therefore, the various orders in the specification and the accompanying drawings are merely for the purpose of clear description of a certain embodiment and are not meant to be a necessary order unless it is otherwise stated that a certain order must be followed.

In the description of this disclosure, it should be understood that the orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, etc. are in accordance with those shown in the accompanying drawings and intended only for the convenience of describing this disclosure and simplifying the description rather than for indicating or implying that the referred apparatus or element must be provided with a particular orientation or constructed and operated in a particular orientation; therefore, they should not be construed as limiting this disclosure. Furthermore, the terms “first” and “second” are intended only for descriptive purposes and should not be construed as indicating or implying their relative importance or implying the quantity of technical features indicated. Therefore, features defined by “first” and “second” may explicitly or implicitly include one or more of such features. In the description of this disclosure, unless otherwise specified, “a plurality of” refers to two or more.

In the description of this disclosure, it should be noted that, unless otherwise explicitly provided and limited, the terms “mounted”, “connected”, and “connection” should be understood in a broad sense, e.g., it may be a fixed connection, a detachable connection, or an integral connection; it may be a mechanical connection or an electrical connection; it may be a direct connection or an indirect connection through an intermediate medium; and it may be a connection between two elements. For a person of ordinary skill in the art, the specific meanings of the above terms in this disclosure may be understood based on specific circumstances.

This disclosure will be described in detail below with reference to the accompanying drawings and the embodiments.

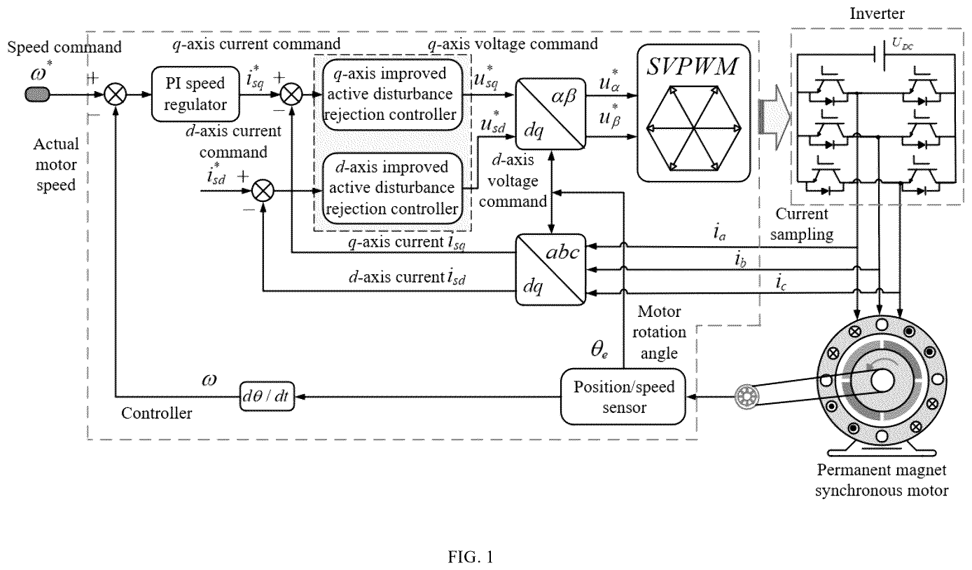

In an embodiment of this disclosure, a current harmonic disturbance suppressing method of a permanent magnet synchronous motor based on enhanced ADRC is provided. This method is applied to a permanent magnet synchronous motor system as shown in FIG. 1 to estimate and compensate for periodic harmonic disturbance and aperiodic disturbance. The permanent magnet synchronous motor system adopts a cascade double closed-loop structure including a speed loop and a current loop. Specifically, the speed loop is adjusted by a PI controller to output a q-axis reference current; and the current loop is regulated by an invented control solution to output d-axis and q-axis reference voltages. In addition, a designed harmonic suppression link having multiple frequency selection characteristics is integrated into an extended state observer, so as to form an enhanced ADRC framework together with a control law. The integral link in the observer is used to estimate the aperiodic disturbance, while the harmonic suppression link is introduced to accurately estimate multiple harmonic disturbances.

A speed command ω*, which is an expected speed value of the motor, is an input target of the whole control system.

A position/speed sensor is used to obtain an actual speed of the motor and perform closed-loop feedback control on the actual speed, so that the system can correct a speed deviation in real time and improve control accuracy.

A PI speed regulator, which is used to receive a speed error obtained by comparing the actual speed with the speed command, and process the error through proportional (P) and integral (I) operations, so that the system can accurately track the speed command at a steady state.

A d-axis current command

$${i}_{sd}^{*}$$

is used to control flux of the motor.

A q-axis current command

$${i}_{s q}^{*}$$

is used to adjust torque of the motor.

A d-axis enhanced ADRC and a q-axis enhanced ADRC are used to control d-axis and q-axis currents, respectively, and to suppress influence of various disturbances in the system such as load changes and motor parameter changes on the current control.

According to reference and feedback values of the current, corresponding d-axis and q-axis voltage commands

$${u}_{s d}^{*} and {u}_{s q}^{*}$$

are output, enabling the actual current to accurately track the command current and ensuring stable motor operation.

abc/dq transformation is used to convert a current feedback value in a three-phase stationary coordinate system (abc) into a current value in a two-phase rotating coordinate system (dq).

dq/αβ transformation is used to convert signals between different control links.

Space vector pulse width modulation (SVPWM) is used to receive voltage commands

$${u}_{α}^{*} and {u}_{β}^{*}$$

in the αβ coordinate system and calculate a signal for controlling a switch tube of an inverter through a specific algorithm.

The inverter is composed of a plurality of power switch tubes, converts direct current into three-phase alternating current according to a switching signal output by a SVPWM module, and is used to drive the three-phase winding of the permanent magnet synchronous motor, so that the motor can rotate normally.

Current sampling is used to perform real-time sampling on the three-phase alternating current in the operation of the motor, obtain actual operation current information of the motor, and feed the current information back to the control system for comparison with the current command to form current closed-loop control.

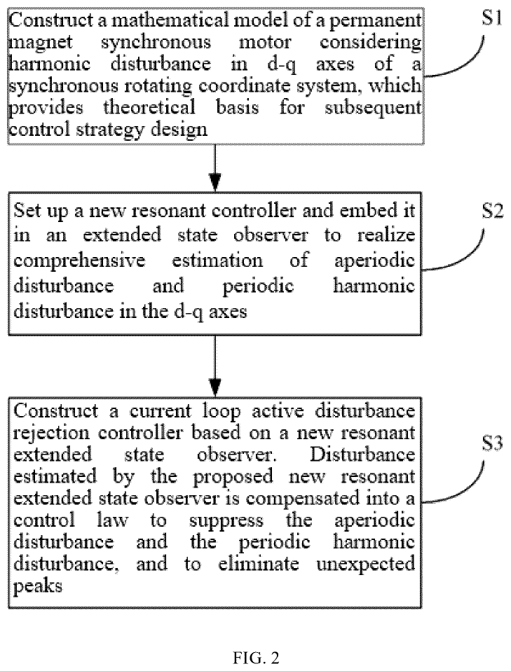

For the current harmonic disturbance of the above system, this disclosure provides a current harmonic disturbance suppressing method of a permanent magnet synchronous motor as shown in FIG. 2, and specific steps are as follows:
S1: Firstly, a stator current equation of the permanent magnet synchronous motor is established and expressed as:

$$\{ \begin{matrix}\frac{d}{dt} {i}_{sd} = - \frac{{R}_{s}}{{L}_{sd}} {i}_{sd} + \frac{{n}_{p} {ω}_{m} {L}_{sq}}{{L}_{sd}} {i}_{sq} + \frac{1}{{L}_{d}} {u}_{sd} \\ \frac{d}{dt} {i}_{sq} = - \frac{{R}_{s}}{{L}_{sq}} {i}_{sq} - \frac{{n}_{p} {ω}_{m} {L}_{sq}}{{L}_{sq}} {i}_{sd} - \frac{{n}_{p} {ω}_{m} {ψ}_{f}}{{L}_{sq}} + \frac{1}{{L}_{sq}} {u}_{sq}\end{matrix} \qquad ( 1 )$$

where t represents time, i_{sd} represents a d-axis stator current, i_{sq} represents a q-axis stator current, L_{sd} represents a d-axis inductance, L_{sq} represents a q-axis inductance, because the d-axis inductance and the q-axis inductance of a surface-mounted permanent magnet synchronous motor are the same, they can be expressed by Lₛ, L_{sd}=L_{sq}=Lₛ, Rₛ represents a stator resistance, nₚ represents the number of pole pairs of the motor, ωₘ represents a mechanical angular velocity of the motor, and ψ_{f} represents permanent magnet flux linkage.

Based on the stator current equation of the permanent magnet synchronous motor, harmonic sources in the motor system are analyzed and calculated, and periodic current harmonics introduced by various factors are calculated, specifically including:
Because the permanent magnet of the permanent magnet synchronous motor is not a perfect ideal magnet, there may be a certain degree of unevenness in its magnetic field distribution, or flux harmonics may be generated on the d-q axes due to the influence of armature reaction and other factors during the operation of the motor. Therefore, according to the above stator current equation (1), the harmonics of flux in the d-axis and q-axis directions are deduced and calculated, and the harmonics of permanent magnet flux under the d-q axes are obtained as follows:

$$\{ \begin{matrix}{ψ}_{d \_ har} = {\sum }_{k = 1}^{∞} {ψ}_{d \_ har ( 6 k )} cos ( 6 {kn}_{p} {ω}_{m} t ) \\ {ψ}_{q \_ har} = {\sum }_{k = 1}^{∞} {ψ}_{q \_ har ( 6 k )} sin ( 6 {kn}_{p} {ω}_{m} t )\end{matrix} \qquad ( 2 )$$

where ψ_{d_har} represents d-axis flux harmonics, ψ_{q_har} represents q-axis flux harmonics, ψ_{d_har(6k)} represents a magnitude of 6k harmonic on the d-axis, ψ_{q_har(6k)} represents a magnitude of 6k harmonic on the q-axis, k is an integer, and the 6k harmonics indicate that the frequency of the harmonic is 6k times that of a fundamental frequency.

In the inverter, a dead time is set to prevent the short circuit caused by simultaneous conduction of switch tubes of upper and lower bridge arms. However, the existence of the dead time can lead to the difference between a PWM waveform output by the inverter and an ideal waveform, thus generating voltage harmonics. The voltage harmonics caused by inverter dead-time effect can be expressed as:

$$\{ \begin{matrix}Δ {u}_{d \_ har} = \frac{4 {T}_{dead} {U}_{dc}}{π {T}_{s}} {\sum }_{k = 1}^{∞} [ \frac{12 k}{36 {k}^{2} - 1} sin ( 6 {kn}_{p} {ω}_{m} t ) ] \\ Δ {u}_{q \_ har} = \frac{4 {T}_{dead} {U}_{dc}}{π {T}_{s}} \{ {\sum }_{k = 1}^{∞} [ \frac{2}{36 {k}^{2} - 1} cos ( 6 {kn}_{p} {ω}_{m} t ) ] - 1 \}\end{matrix} \qquad ( 3 )$$

where Δu_{d_har} represents d-axis voltage harmonics, Δdu_{q_har} represents q-axis voltage harmonics, T_{dead} represents the dead time, Tₛ represents sampling period, and U_{dc} represents a direct voltage.

The d-q axis harmonic disturbance of the current loop is defined as follows:

f_{s_p}=N[Δuₕₐᵣ+nₚωₘψₕₐᵣ] (4)
where f_{s_p}=[f_{sd_p} f_{sq_p}]^{T}, f_{s_p} represents the d-q axis harmonic disturbance, f_{sd_p} represents d-axis harmonic disturbance, f_{sq_p} represents q-axis harmonic disturbance,

$$Δ {u}_{har} = [ \begin{matrix}Δ {u}_{d \_ har} \\ Δ {u}_{q \_ har}\end{matrix} ] ,$$

Δuₕₐᵣ represents d-q axis voltage harmonics caused by inverter dead-time effect, Δu_{d_har} represents d-axis voltage harmonics caused by inverter dead-time effect, Δu_{q_har} represents q-axis voltage harmonics caused by inverter dead-time effect,

$${ψ}_{har} = [ \begin{matrix}{ψ}_{q \_ har} \\ - {ψ}_{d \_ har}\end{matrix} ] ,$$

ψₕₐᵣ represents d-q axis permanent magnet flux harmonics, ψ_{d_har} represents d-axis flux harmonics, ψ_{q_har} represents q-axis flux harmonics, N=[[1/(ΔL_{sd}+Lₛ₀) 0][0 1/(ΔL_{sq}+Lₛ₀)]]^{T}, nₚ represents the number of pole pairs of the motor, ωₘ represents a mechanical angular velocity of the motor, ΔL_{sd}=L_{sd}−L_{sd0}, ΔL_{sd} represents an error between d-axis actual inductance L_{sd} and nominal d-axis inductance L_{sd0}, ΔL_{sq}=L_{sq}−L_{sq0}, ΔL_{sq} represents an error between q-axis actual inductance L_{sq} and nominal q-axis inductance L_{sq0}, and ΔL_{sd}=L_{sq0}−Lₛ₀.

Because system parameters are uncertain and time-varying, the current loop will also be affected by aperiodic disturbance on the d-q axis. In the embodiments of this disclosure the d-q axis aperiodic disturbance of the current loop is defined as:

$$\{ \begin{matrix}{f}_{sd \_ ap} = \frac{Δ {L}_{sd} {R}_{s 0} - {L}_{s 0} Δ {R}_{s}}{{L}_{s 0} ( Δ {L}_{sd} + {L}_{s 0} )} {i}_{sd} + \frac{{n}_{p} {ω}_{m} ( Δ {L}_{sq} - Δ {L}_{sd} )}{Δ {L}_{sd} + {L}_{s 0}} {i}_{sq} - \\ \frac{Δ {L}_{sd}}{{L}_{s 0} ( Δ {L}_{sd} + {L}_{s 0} )} {u}_{sd} + {δ}_{sd} \\ {f}_{sq \_ ap} = \frac{Δ {L}_{sq} {R}_{s 0} - {L}_{s 0} Δ {R}_{s}}{{L}_{s 0} ( Δ {L}_{sq} + {L}_{s 0} )} {i}_{sq} - \frac{{n}_{p} {ω}_{m} ( Δ {L}_{sd} - Δ {L}_{sq} )}{Δ {L}_{sq} + {L}_{s 0}} {i}_{sd} - \\ \frac{Δ {L}_{sq}}{{L}_{s 0} ( Δ {L}_{sq} + {L}_{s 0} )} {u}_{sq} + \frac{- {L}_{s 0} Δ {ψ}_{f} + Δ {L}_{sq} {ψ}_{{f}_{0}}}{{L}_{s 0} ( Δ {L}_{sq} + {L}_{s 0} )} {n}_{p} {ω}_{m} + {δ}_{sq}\end{matrix} \qquad ( 5 )$$

where f_{sd_ap} represents d-axis aperiodic disturbance, f_{sq_ap} represents q-axis aperiodic disturbance, ΔRₛ=Rₛ−Rₛ_{₀}, ΔRₛ represents an error between actual resistance Rₛ and nominal resistance Rₛ_{₀}, ΔL_{sd}=L_{sd}−L_{sd0}, ΔL_{sd}=L_{sd}−L_{sd0}, ΔL_{sq}=L_{sq}−L_{sq0}, L_{sd0} and L_{sq0} represent d-axis and q-axis nominal inductances respectively, Δψ_{f}=ψ_{f}−ψ_{f0}, Δψ_{f} represents an error between flux linkage of the motor ψ_{f} and nominal flux linkage ψ_{f}_{₀}, δ_{sd} represents d-axis uncertainty disturbance, and δ_{sq} represents q-axis uncertainty disturbance.

Based on the above factors, the d-axis disturbance can be obtained: f_{sd}=f_{sd_ap}+f_{sd_p}; and the q-axis disturbance can be obtained: f_{sq}=f_{sq_ap}+f_{sq_p}. In addition, nonlinear behaviors such as a magnitude limiting saturation operation will occur in the control system, which will lead to voltage mismatch between the d-axis and the q-axis, thus causing aperiodic disturbance. Therefore, on the basis of f_{sd} and f_{sq}, it is necessary to further consider the aperiodic disturbance caused by the voltage mismatch, and after considering total disturbance composed of the periodic harmonic disturbance and the aperiodic disturbance, a current loop mathematical model of the permanent magnet synchronous motor can be rewritten as:

$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {i}_{sq} = {γ}_{0} {u}_{sq}^{*} + {f}_{sq 0} + {f}_{sq}^{t}\end{matrix} \qquad ( 6 )$$

where γ₀ represents current control gain,

$${γ}_{0} = 1 / {L}_{s 0} , {u}_{sd}^{*}$$

represents a d-axis stator reference voltage,

$${u}_{sq}^{*}$$

represents a q-axis stator reference voltage, f_{sd0} represents known d-axis disturbance,

$${f}_{sd 0} = - \frac{{R}_{s 0} {i}_{sd}}{{L}_{s 0}} + {n}_{p} {ω}_{m} {i}_{sq} ,$$

f_{sq0} represents known q-axis disturbance,

$${f}_{sq 0} = - \frac{{R}_{s 0} {i}_{sq}}{{L}_{s 0}} - {n}_{p} {ω}_{m} {i}_{sd} - {n}_{p} {ω}_{m} \frac{{ψ}_{f 0}}{{L}_{s 0}} , {f}_{sd}^{t}$$

represents d-axis total disturbance with further consideration of voltage mismatch on the basis of f_{sd},

$${f}_{sd}^{t} = {f}_{sd} + {γ}_{0} ( {u}_{sd} - {u}_{sd}^{*} ) , and {f}_{s q}^{t}$$

represents q-axis total disturbance with further consideration of voltage mismatch on the basis of f_{sq},

$${f}_{sq}^{t} = {f}_{sq} + {γ}_{0} ( {u}_{sq} - {u}_{sq}^{*} ) .$$

In order to facilitate subsequent design of the extended state observer, the d-q axis total disturbance is defined as an extended state of the motor system, that is, as one of the state variables, and then the total disturbance is estimated in real time by using the extended state observer, so as to compensate for the total disturbance in a control strategy.

After the d-q axis total disturbance is defined as the extended state of the motor system, the obtained extended state system is as follows:

$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {f}_{sd}^{t} = {𝒩}_{sd}\end{matrix} \qquad ( 7 )$$

$$\{ \begin{matrix}\frac{d}{dt} {i}_{sq} = {γ}_{0} {u}_{sq}^{*} + {f}_{sq 0} + {f}_{sq}^{t} \\ \frac{d}{dt} {f}_{sq}^{t} = {𝒩}_{sq}\end{matrix} \qquad ( 8 )$$

where

$${f}_{sd}^{t} and {f}_{sq}^{t}$$

are assumed to be differentiable, [symbol] _{sd} is a derivative of the d-axis total disturbance, and [symbol] _{g} is a derivative of the q-axis total disturbance.
S2: It should be specially noted that although increasing the bandwidth of the traditional extended state observer can significantly enhance its ability of observing disturbances, it will inevitably amplify noise and reduce the robustness of the system. In addition, a traditional resonant controller (TRSC)-based extended state observer (TRSC-ESO) has obvious advantages in enhancing the ability of observing harmonic disturbance. However, this method often introduces unexpected peak phenomena near the resonance frequency, thus amplifying the noise in this frequency band and even causing system instability. Therefore, an objective of this disclosure is to design an improved resonant controller (IRSC)-based extended state observer (IRSC-ESO). By optimizing the resonance characteristics and observer structure, the ability of suppressing harmonic disturbance is enhanced, and meanwhile, the unexpected peaks near the resonance frequency are effectively eliminated.

In order to realize the comprehensive suppression of aperiodic disturbance and periodic harmonic disturbance and to avoid the unexpected peaks, an improved resonant controller (IRSC) G_{IRSC}(s) is designed for any frequency harmonic in the embodiments of this disclosure as follows:

$${G}_{IRSC} ( s ) = \frac{{k}_{r} {ω}_{c} {Δ}_{1}}{{s}^{2} + 2 {ω}_{c} s + {ω}_{h}^{2}} \qquad ( 9 )$$

where kᵣ represents resonance gain, ω_{c} represents a resonance bandwidth, ωₕ represents a resonance frequency,

$${Δ}_{1} = {s}^{2} + 2 {ω}_{o} s + {ω}_{o}^{2} ,$$

s represents a Laplace complex frequency variable, and ωₒ represents a bandwidth of an extended state observer.

Because there are a plurality of harmonic disturbances, in order to effectively suppress the plurality of harmonic disturbances, it is necessary to extend the function of the improved resonant controller, so that it can suppress multi-frequency harmonic disturbance. Therefore, on the basis of Equation (9), when suppressing the multi-frequency harmonic disturbance, an expression of the improved resonant controller G_{IRSC}_{ₛ}(s) that is extended and generalized based on multi-frequency is as follows:

$${G}_{{IRSC}_{S}} ( s ) = \frac{{k}_{r 1} {ω}_{c 1} {Δ}_{1}}{{s}^{2} + 2 {ω}_{c 1} s + {ω}_{h 1}^{2}} + \frac{{k}_{r 2} {ω}_{c 2} {Δ}_{1}}{{s}^{2} + 2 {ω}_{c 2} s + {ω}_{h 2}^{2}} + … + \frac{{k}_{r n} {ω}_{c n} {Δ}_{1}}{{s}^{2} + 2 {ω}_{c n} s + {ω}_{h n}^{2}} \qquad ( 10 )$$

where kᵣ₁, kᵣ₂, . . . , kᵣₙ represent resonance gains of different frequencies, ω_{c1}, ω_{c2}, . . . , ω_{cn} represent resonance bandwidths of different frequencies, and ωₕ₁, wₕ₂, . . . , ωₕₙ represent resonance frequencies of different frequencies.

Considering that the harmonic magnitude decreases with the increase of the harmonic order number, only influences of 6th and 12th harmonic disturbances are considered. For the 6th and 12th harmonic disturbances, the improved resonant controller G_{IRSC}_{ₛ}(s) is designed as follows:

$${G}_{IRSCs} ( s ) = \frac{{k}_{r 1} {ω}_{c 1} {Δ}_{1}}{{s}^{2} + 2 {ω}_{c 1} s + {ω}_{h 1}^{2}} + \frac{{k}_{r 2} {ω}_{c 2} {Δ}_{1}}{{s}^{2} + 2 {ω}_{c 2} s + {ω}_{h 2}^{2}} \qquad ( 11 )$$

where ωₕ₁=6nₚωₘ, and ωₕ₂=12nₚωₘ.

For the current loop mathematical model of the permanent magnet synchronous motor expressed by Equation (6), an extended state observer is designed, and the improved resonant controller is embedded in the extended state observer to obtain improved d-axis and q-axis resonant-extended state observers as follows

$$\{ \begin{matrix}\frac{d}{dt} {\hat{ι}}_{sd} = {γ}_{0} {u}_{sd}^{*} + {f}_{sd 0} + \hat{{f}_{sd}^{t}} + {λ}_{1} ( {i}_{sd} - {\hat{ι}}_{sd} ) \\ \begin{matrix}\hat{{f}_{sd}^{t}} = {\hat{f}}_{sd\_ap}^{t} + {\hat{f}}_{sd\_p}^{t} , & {\hat{f}}_{sd\_p}^{t} = {κ}_{2} + {κ}_{4}\end{matrix} \\ {ϑ}_{sd} = ( {i}_{sd} - {\hat{ι}}_{sd} ) + \frac{d}{dt} ( {i}_{sd} - {\hat{ι}}_{sd} ) + \int ( {i}_{sd} - {\hat{ι}}_{sd} ) d t \\ \begin{matrix}\frac{d}{dt} {κ}_{1} = {κ}_{2} , & \frac{d}{dt} {κ}_{3} = {κ}_{4}\end{matrix} \\ \frac{d}{dt} {κ}_{2} = - {ω}_{h 1}^{2} {κ}_{1} + {λ}_{2} {k}_{r 1} {ω}_{c 1} {ϑ}_{sd} - 2 {ω}_{c 1} {κ}_{2} \\ \frac{d}{dt} {\hat{f}}_{sd\_ap}^{t} = {λ}_{2} ( {i}_{sd} - {\hat{ι}}_{sd} ) \\ \frac{d}{dt} {κ}_{4} = - {ω}_{h 2}^{2} {κ}_{3} + {λ}_{2} {k}_{r 2} {ω}_{c 2} {ϑ}_{sd} - 2 {ω}_{c 2} {κ}_{4}\end{matrix} \qquad ( 12 )$$

$$\{ \begin{matrix}\frac{d}{dt} {\hat{ι}}_{s q} = {γ}_{0} {u}_{s q}^{*} + {f}_{s q 0} + \hat{{f}_{s q}^{t}} + {λ}_{1} ( {i}_{s q} - {\hat{ι}}_{s q} ) \\ \begin{matrix}\hat{{f}_{s q}^{t}} = {\hat{f}}_{sq\_ap}^{t} + {\hat{f}}_{sq\_p}^{t} , & {\hat{f}}_{sq\_p}^{t} = {κ}_{2} + {κ}_{4}\end{matrix} \\ {ϑ}_{s q} = ( {i}_{s q} - {\hat{ι}}_{s q} ) + \frac{d}{dt} ( {i}_{s q} - {\hat{ι}}_{s q} ) + \int ( {i}_{s q} - {\hat{ι}}_{s q} ) d t \\ \begin{matrix}\frac{d}{dt} {κ}_{1} = {κ}_{2} , & \frac{d}{dt} {κ}_{3} = {κ}_{4}\end{matrix} \\ \frac{d}{dt} {κ}_{2} = - {ω}_{h 1}^{2} {κ}_{1} + {λ}_{2} {k}_{r 1} {ω}_{c 1} {ϑ}_{s q} - 2 {ω}_{c 1} {κ}_{2} \\ \frac{d}{dt} {\hat{f}}_{sq\_ap}^{t} = {λ}_{2} ( {i}_{s q} - {\hat{ι}}_{s q} ) \\ \frac{d}{dt} {κ}_{4} = - {ω}_{h 2}^{2} {κ}_{3} + {λ}_{2} {k}_{r 2} {ω}_{c 2} {ϑ}_{s q} - 2 {ω}_{c 2} {κ}_{4}\end{matrix} \qquad ( 13 )$$

where \hat{l}_{sd} represents a d-axis stator current estimate, \hat{l}_{sq} represents a q-axis stator current estimate,

$$\hat{{f}_{sd}^{t}}$$

represents a d-axis total disturbance estimate,

$$\hat{{f}_{s q}^{t}}$$

represents a q-axis total disturbance estimate,

$${\hat{f}}_{sd\_ap}^{t}$$

represents a d-axis aperiodic disturbance estimate

$${\hat{f}}_{sq\_ap}^{t}$$

represents a q-axis aperiodic disturbance estimate,

$${\hat{f}}_{sd\_p}^{t}$$

represents a d-axis harmonic disturbance estimate,

$${\hat{f}}_{sq\_p}^{t}$$

represents a q-axis harmonic disturbance estimate, κ₁, κ₂, κ₃, and κ₄ represent state variables of the improved resonant controller, λ₁ and λ₂ represent gain coefficients of the extended state observer, and ϑ_{sd} and ϑ_{sq} represent intermediate variables.

Furthermore, according to a pole assignment strategy, a gain coefficient of an n-order extended state observer with the characteristic equation meeting sⁿ⁺¹+λ₁sⁿ+ . . . +λₙs+λₙ₊₁=(s+ωₒ)ⁿ⁺¹ is as follows:

$${λ}_{i} = \frac{{ω}_{o}^{i} ( n + 1 ) !}{i ! ( n + 1 - i ) !} \qquad ( 14 )$$

where i=1,2, . . . , n+1, and ωₒ is defined as the observer bandwidth. Therefore, it can be concluded that the gain coefficient of the improved resonant controller-based extended state observer is

$${λ}_{1} = 2 {ω}_{o} , {λ}_{2} = {ω}_{o}^{2} .$$

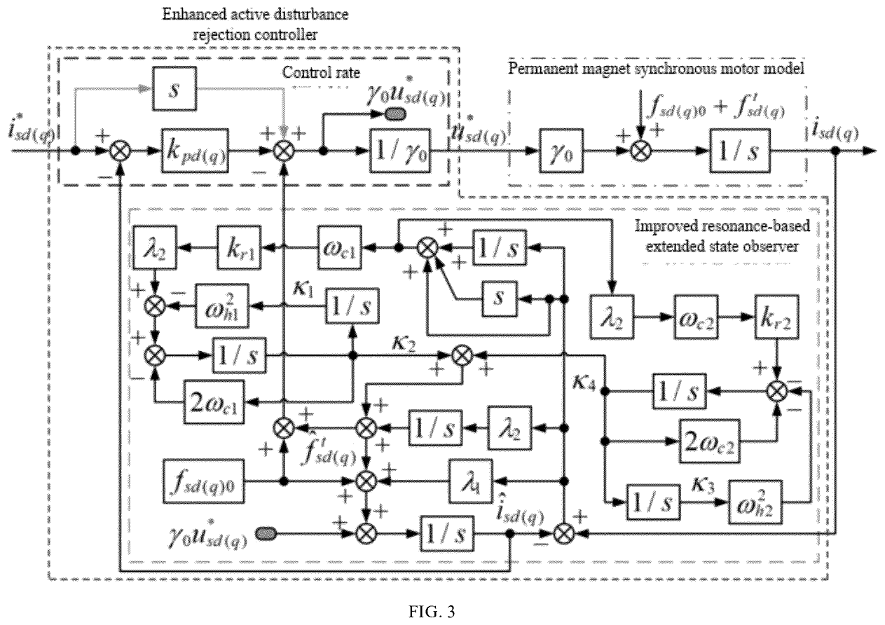

S3: As shown in FIG. 3, the total disturbance obtained by the resonant-extended state observer in S2 is introduced into a control terminal as a feedforward signal, and a reasonable control law is designed to realize the enhanced ADRC of the improved resonant controller-based extended state observer, and the observed disturbance signal is accurately suppressed and eliminated, thus further enhancing the control accuracy and robustness of the system. Specifically, the d-axis reference current

$${i}_{sd}^{*}$$

and the q-axis reference current

$${i}_{sq}^{*}$$

are used to define

$${e}_{{i}_{sd}} = {i}_{sd}^{*} - {i}_{sd} , {e}_{{i}_{sq}} = {i}_{sq}^{*} - {i}_{sq} ,$$

the following can be obtained:

$$\{ \begin{matrix}{\dot{e}}_{{i}_{sd}} = {i}_{sd}^{*} - {i}_{sd} = {i}_{sd}^{*} - {γ}_{0} {u}_{sd}^{*} - {f}_{sd 0} - {f}_{sd}^{t} \\ {\dot{e}}_{{i}_{sq}} = {i}_{sq}^{*} - {i}_{sq} = {i}_{sq}^{*} - {γ}_{0} {u}_{sq}^{*} - {f}_{sq 0} - {f}_{sq}^{t}\end{matrix} \qquad ( 15 )$$

By using proportional control, an error convergence control law can be expressed as:

$$\{ \begin{matrix}{\dot{e}}_{sd} = - {k}_{pd} {e}_{id} \\ {\dot{e}}_{sq} = - {k}_{pq} {e}_{iq}\end{matrix} \qquad ( 16 )$$

where k_{pd} and k_{pq} are d-axis and q-axis current loop controller gains, respectively.

By substituting Equation (16) into Equation (15), the following can be obtained:

$$\{ \begin{matrix}{u}_{sd}^{*} = \frac{{i}_{sd}^{*} + {k}_{pd} ( {i}_{sd}^{*} - {i}_{sd} ) - {f}_{sd 0} - {f}_{sd}^{t}}{{γ}_{0}} \\ {u}_{sq}^{*} = \frac{{i}_{sq}^{*} + {k}_{pq} ( {i}_{sq}^{*} - {i}_{sq} ) - {f}_{sq 0} - {f}_{sq}^{t}}{{γ}_{0}}\end{matrix} \qquad ( 17 )$$

In Equation (17), the total disturbance is unknown, and an observed value is usually used instead of an actual value. In addition, in order to reduce the influence of measurement noise, a current estimated by the observer is used instead of an actual current. Thus, the control law can be rewritten as:

$$\{ \begin{matrix}{u}_{sd}^{*} = \frac{{i}_{sd}^{*} + {u}_{d 0} - {f}_{sd 0} - {\hat{f}}_{sd}^{t}}{{γ}_{0}} \\ {u}_{sq}^{*} = \frac{{i}_{sq}^{*} + {u}_{q 0} - {f}_{sq 0} - {\hat{f}}_{sq}^{t}}{{γ}_{0}}\end{matrix} \qquad ( 18 )$$

where

$${u}_{d 0} = {k}_{pd} ( {i}_{sd}^{*} - {\hat{l}}_{sd} ) , {u}_{q 0} = {k}_{pq} ( {i}_{sq}^{*} - {\hat{l}}_{sq} ) , {\hat{f}}_{sd}^{t} and {\hat{f}}_{sq}^{t}$$

are total disturbance estimates obtained from observation in S2, which can realize compensation of the unknown disturbance, and reference differential feedforward

$${i}_{sd}^{*} and {i}_{sq}^{*}$$

are used to reduce oscillation and overshoot phenomena in a dynamic process of the system, and significantly shorten an adjustment time of the system at the same time.

If all disturbances can be accurately compensated for, the d-q axis system can be simplified as an integrator, that is:

$$\{ \begin{matrix}\frac{d}{dt} {i}_{sd} = {i}_{sd}^{*} + {u}_{d 0} - {f}_{sd 0} - {\hat{f}}_{sd}^{t} + {f}_{sd 0} + {f}_{sd}^{t} \approx {u}_{d 0} \\ \frac{d}{dt} {i}_{sq} = {i}_{sq}^{*} + {u}_{q0} - {f}_{sq 0} - {\hat{f}}_{sq}^{t} + {f}_{sq 0} + {f}_{sq}^{t} \approx {u}_{q0}\end{matrix} \qquad ( 19 )$$

Further, in order to verify the superiority of the improved resonant controller-extended state observer, this disclosure conducts comparative experiments on the traditional extended state observer (ESO), the traditional resonant controller (TRSC)-based extended state observer (TRSC-ESO), and the improved resonant controller (IRSC)-based extended state observer (IRSC-ESO), and the obtained results are as follows:

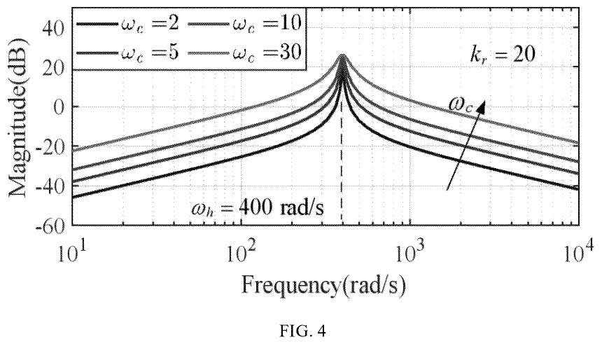

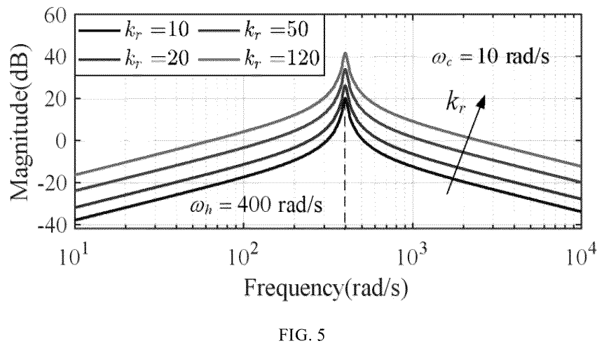

FIG. 4 and FIG. 5 respectively show a Bode diagram of a traditional quasi-resonant controller when ω_{c} changes from 2 rad/s to 30 rad/s and kᵣ changes from 10 to 120, where the horizontal coordinate is frequency in rad/s and the vertical coordinate is resonance magnitude in dB.

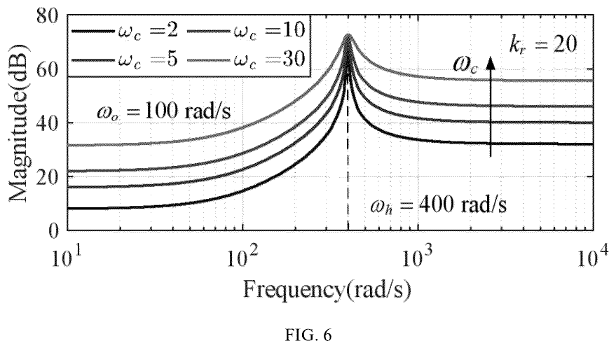

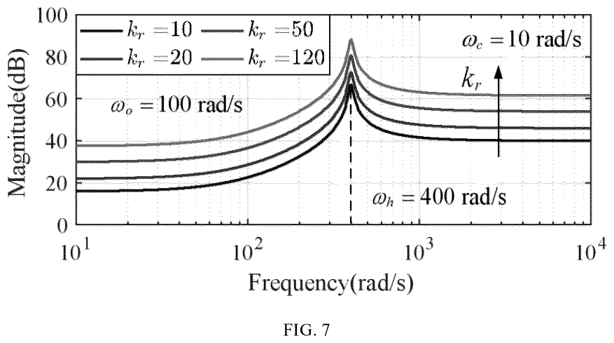

FIG. 6 and FIG. 7 respectively show a Bode diagram of an improved resonant controller when ω_{c} changes from 2 rad/s to 30 rad/s and kᵣ changes from 10 to 120, with a bandwidth ωₒ of 100 rad/s, where the horizontal coordinate is frequency in rad/s and the vertical coordinate is resonance magnitude in dB.

It can be seen from FIG. 4 to FIG. 7 that both the improved resonant controller and the traditional quasi-resonant controller show significant peak magnitude at a resonance frequency, and this feature plays a key role in suppressing the harmonic disturbance of a target frequency. In addition, the resonance bandwidth can be significantly widened by increasing ω_{c} parameters of the two controllers, thus improving the robustness of the system to resonance frequency changes; and the suppression performance of the two controllers is further strengthened at the target resonance frequency by increasing the resonance gain kᵣ, thus effectively enhancing the harmonic suppression effect of the system. However, the magnitude-frequency response characteristics outside the resonance frequency of the two controllers are obviously different: the traditional quasi-resonant controller shows a typical magnitude-frequency attenuation characteristic of −20 dB/dec outside the resonance frequency, while the improved resonant controller can maintain the magnitude-frequency response of 0 dB outside the resonance frequency.

Further, in order to illustrate and verify the superiority of estimating and compensating for the total disturbance by using the IRSC-ESO, the current loop mathematical model of the permanent magnet synchronous motor and the TRSC-ESO considering the total disturbance are analyzed, and when kᵣ=0, a transfer function Gₑ₁(s) between a disturbance estimation error of the ESO and an actual disturbance can be obtained as follows:

$${G}_{e 1} ( s ) = \frac{{F}_{d} ( s ) - {\hat{F}}_{d} ( s )}{{F}_{d} ( s )} = \frac{{G}_{0} ( s )}{{Δ}_{1} ( s )} \qquad ( 20 )$$

where F_{d}(s) represents an actual disturbance signal, \hat{F}_{d}(s) represents a disturbance estimate obtained by the ESO, Δ₁(s)=s²+λ₁s+λ₂, and G₀(s)=Δ₁(s)−λ₂=s(s+λ₁).

Similarly, a transfer function Gₑ₂(s) between a disturbance estimation error of the TRSC-ESO and an actual disturbance can be derived as follows:

$${G}_{e 2} ( s ) = \frac{{F}_{d} ( s ) - {\hat{F}}_{d} ( s )}{{F}_{d} ( s )} = \frac{{G}_{0} ( s )}{{σ}_{1} ( s )} \qquad ( 21 )$$

where F_{d}(s) represents an actual disturbance signal, \hat{F}_{d}(s) represents a disturbance estimate obtained by the TRSC-ESO,

$$\frac{{G}_{TRSCs} ( s ) = 2 {K}_{r 1} {ω}_{c 1} s}{( {s}^{2} + 2 {ω}_{c 1} s + {ω}_{h 1}^{2} )} + \frac{2 {K}_{r 2} {ω}_{c 2} s}{( {s}^{2} + 2 {ω}_{c 2} s + {ω}_{h 2}^{2} )} , and$$

$${σ}_{1} ( s ) = {Δ}_{1} ( s ) + {λ}_{2} s {G}_{TRSCs} ( s )$$

A transfer function Gₑ₃ (s) between a disturbance estimation error of the IRSC-ESO and an actual disturbance is as follows:

$${G}_{e 3} ( s ) = \frac{{F}_{d} ( s ) - {\hat{F}}_{d} ( s )}{{F}_{d} ( s )} = \frac{{G}_{0} ( s )}{{σ}_{2} ( s )} \qquad ( 22 )$$

where F_{d}(s) represents an actual disturbance signal, \hat{F}_{d}(s) represents a disturbance estimate obtained by the IRSC-ESO, and σ₂(s)=Δ₁(s)+λ₂sG_{IRSCs}(s).

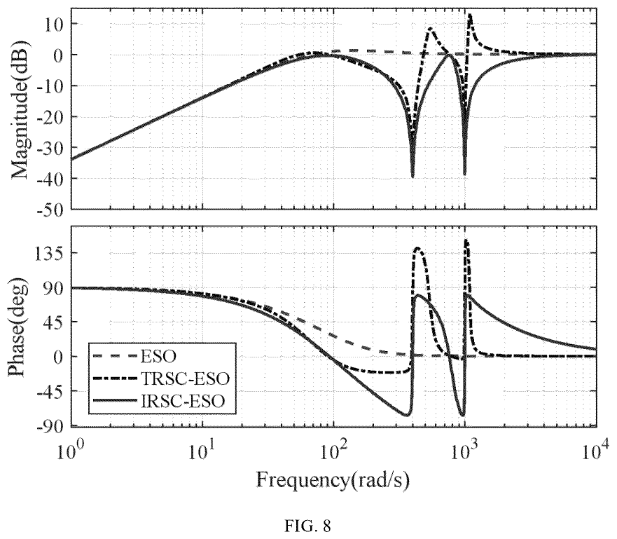

Thus, the Bode diagrams of Gₑ₁(s), Gₑ₂(s), and Gₑ₃(s) can be drawn as shown in FIG. 8, where the bandwidth ωₒ is 100 rad/s, the resonance bandwidth is ω_{c1}=ω_{c1}=4 rad/s, the resonance frequencies ωₕ₁ and ωₕ₂ are 400 rad/s and 1000 rad/s respectively, and the resonance gains of TRSCs and IRSCs are kᵣ=kᵣ₂=0.02.

It can be seen from FIG. 8 that there is little difference in magnitude-frequency characteristics and phase-frequency characteristics between the ESO, TRSC-ESO, and IRSC-ESO in low and high frequency bands, indicating that the three have similar performance in these frequency bands. In addition, both TRSC-ESO and IRSC-ESO show significant magnitude attenuation at the resonance frequency, this significant magnitude attenuation characteristic enables the observer to accurately estimate the harmonic disturbance at a same frequency and shows excellent frequency selectivity. However, it can also be seen from FIG. 8 that the TRSC-ESO has an unexpected peak phenomenon near the resonance frequency, that is, the magnitude-frequency response exceeds 0 dB in some frequency ranges. Compared with the ESO, this peak phenomenon will amplify the disturbance estimation error, and then reduce the estimation effect of actual disturbance, thus affecting the performance of the observer in practical applications. In contrast, the IRSC-ESO successfully eliminates the unexpected peak phenomenon near the resonance frequency through an optimization design. Besides, it requires a lower resonance gain when achieving a same harmonic suppression performance. To sum up, under a same bandwidth condition, the invented IRSC-ESO not only effectively eliminates negative influence of the unexpected peak in the TRSC-ESO, but also shows stronger harmonic suppression performance and superior control performance.

Further, in order to illustrate and verify the progressiveness of the enhanced active disturbance rejection control (EADRC) of the IRSC-ESO, the traditional active disturbance rejection control (ADRC) of the ESO, the improved active disturbance rejection control (IADRC) of the TRSC-ESO, and the EADRC of the IRSC-ESO are compared and analyzed as follows:

Based on the current loop mathematical model of the permanent magnet synchronous motor considering the total disturbance, the TRSC-ESO, and the control law, when kᵣ=0, a transfer function Φ_{f1}(s) output by ADRC under the effect of disturbance can be obtained as follows:

$${Φ}_{f 1} ( s ) = \frac{{i}_{sd} ( s )}{{F}_{d} ( s )} = \frac{{G}_{0} ( s )}{( s + {k}_{pd} ) {Δ}_{1} ( s )} \qquad ( 23 )$$

Similarly, a transfer function Φ_{f2} (s) output by a closed-loop system of IADRC under the effect of disturbance can be deduced as follows:

$${Φ}_{f 2} ( s ) = \frac{{i}_{sd} ( s )}{{F}_{d} ( s )} = \frac{{G}_{0} ( s )}{( s + {k}_{pd} ) [ {Δ}_{1} ( s ) + {λ}_{2} s {G}_{TRSCs} ( s ) ]} \qquad ( 24 )$$

A transfer function Φ_{f3} (s) output by a closed-loop system of EADRC under the effect of disturbance can be deduced as follows:

$${Φ}_{f 3} ( s ) = \frac{{i}_{sd} ( s )}{{F}_{d} ( s )} = \frac{{G}_{0} ( s )}{( s + {k}_{pd} ) [ {Δ}_{1} ( s ) + {λ}_{2} s {G}_{IRSCs} ( s ) ]} \qquad ( 25 )$$

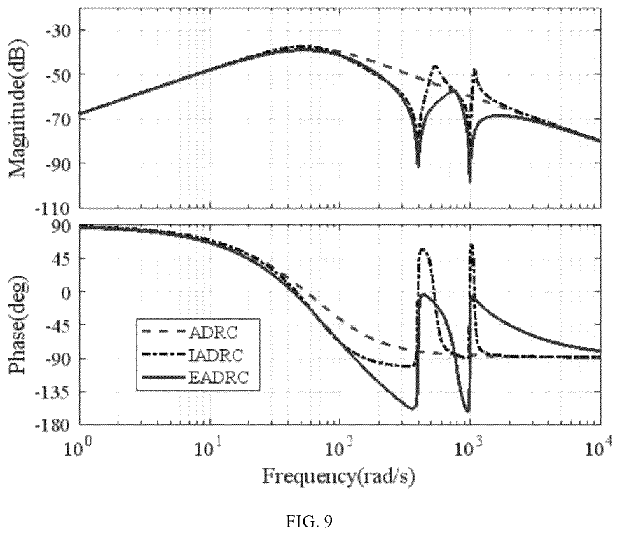

The Bode diagrams of Φ_{f1}(s), Φ_{f2}(s), and Φ_{f3}(s) are drawn as shown in FIG. 9, where the bandwidth ωₒ is 100 rad/s, the resonance bandwidth is ω_{c1}=ω_{c1}=4 rad/s, the resonance frequencies ωₕ₁ and ωₕ₂ are 400 rad/s and 1000 rad/s respectively, the resonance gain of TRSCs is κᵣ₁=Kᵣ₂=2, and the resonance gain of IRSCs is kᵣ₁=kᵣ₂=0.02. It can be seen from frequency-domain characteristic analysis results in FIG. 9 that the three active disturbance rejection controllers have similar performance in the low and high frequency ranges. In addition, both IADRC and EADRC show significant magnitude attenuation characteristics at the resonance frequency, and this characteristic makes them have significant advantages in harmonic disturbance suppression. It should be noted that there is no unexpected peak near the resonance frequency in EADRC, which can improve the stability of the closed-loop system.

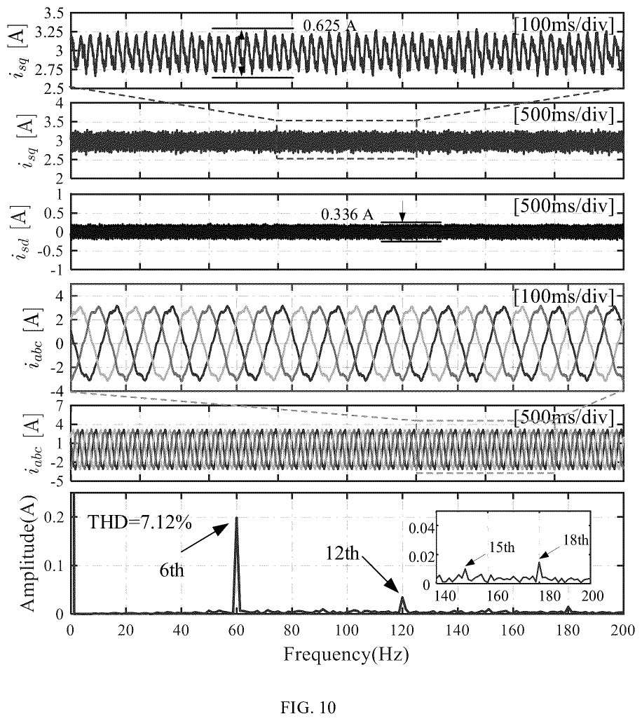

FIG. 10 shows d-q axis and phase current waveforms of a permanent magnet synchronous motor under the traditional ADRC under a working condition of 150 r/min and 3 N·m, where k_{pd}=k_{pq}=150, and ωₒ=100. It can be seen that under the ADRC, a q-axis peak ripple current is 0.625 A, a d-axis peak ripple current is 0.336 A, and a total harmonic distortion of the q-axis current is 7.12%, where the horizontal ordinate is frequency in Hz and the vertical coordinate is current magnitude in A.

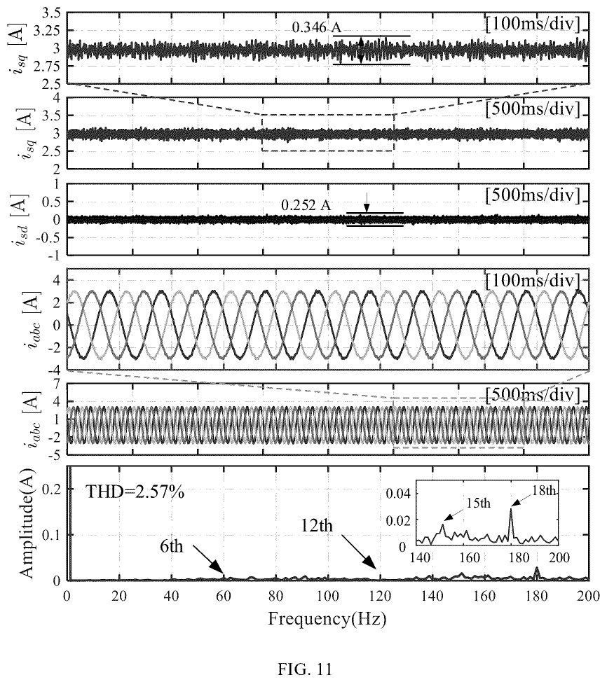

FIG. 11 shows d-q axis and phase current waveforms of a permanent magnet synchronous motor under the IADRC under a working condition of 150 r/min and 3 N·m, where k_{pd}=k_{pq}=150, ωₒ=100, ωₕ₁=6ωₑ, ωₕ₂=12ωₑ, ω_{c1}=ω_{c2}=2, kᵣ₁=2.3, and kᵣ₂=2. It can be clearly seen that under the traditional resonant ADRC, a q-axis peak ripple current is 0.346 A, a d-axis peak ripple current is 0.252 A, and a total harmonic distortion of the q-axis current is 2.57%, which indicates that the IADRC has good harmonic suppression ability. However, it can be found through analysis of Fast Fourier Transform (FFT) that the IADRC introduces an unexpected peak amplification effect near the resonance frequency, and the amplification effect on the 15th and 18th harmonics is particularly significant. This peak effect will not only increase high order harmonics, but also amplify the influence of noise, which leads to the decline of system stability, thus restricting the performance optimization of the control system.

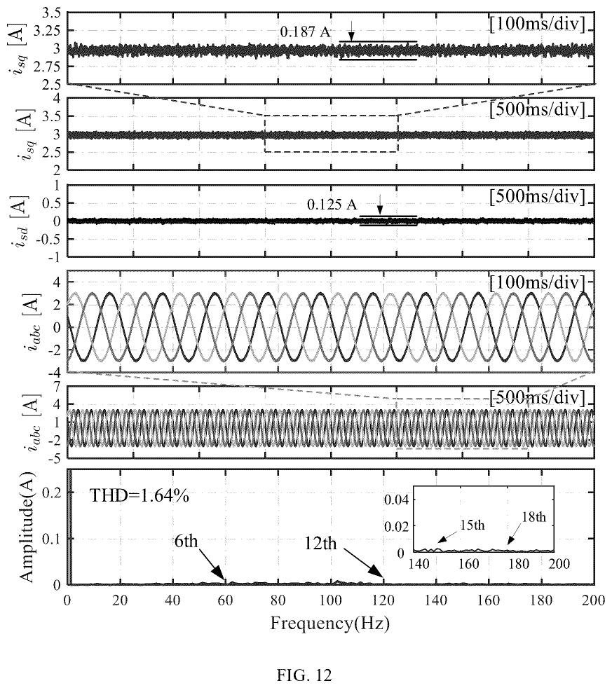

FIG. 12 shows d-q axis and phase current waveforms of a permanent magnet synchronous motor under the EADRC under a working condition of 150 r/min and 3 N m, where k_{pd}=k_{pq}=150, ωₒ=100, ω_{c}=2, Kᵣ₁=0.08, and Kᵣ₂=0.06. It can be clearly seen that under the EADRC, a q-axis peak ripple current is 0.187 A, a d-axis peak ripple current is 0.125 A, and a total harmonic distortion of the q-axis current is 1.64%. It can be found through comparison with FIG. 10 that the EADRC method of this disclosure has obvious advantages in suppressing periodic harmonics and effectively reduces the influence of harmonics on system performance. It can be seen from further comparison with FIG. 11 that the EADRC requires less resonance gain than the IADRC. Although the gain is less, the EADRC is still superior to the IADRC in harmonic suppression, and effectively overcomes common unexpected peak problems in traditional control methods. Specifically, the EADRC can not only suppress the target harmonics, but also avoid amplifying the harmonics and noise of its nearby frequencies, thus significantly improving the stability of the system. In addition, thanks to a larger bandwidth design, the EADRC also reduces the magnitude of 15th and 18th high order harmonics. This characteristic further improves the quality of motor current and reduces the disturbance of harmonics on motor operation stability, thus providing a better guarantee for the high-performance operation of the system.

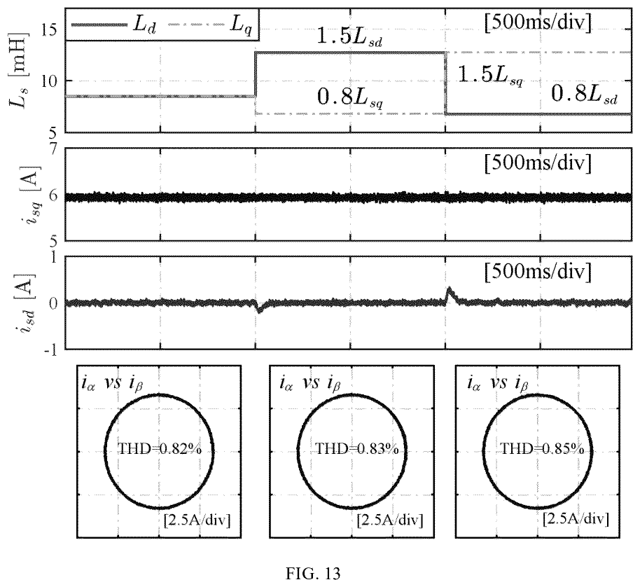

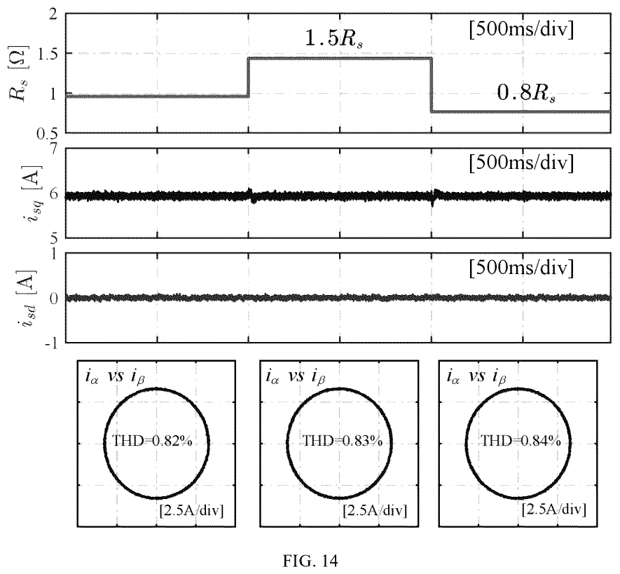

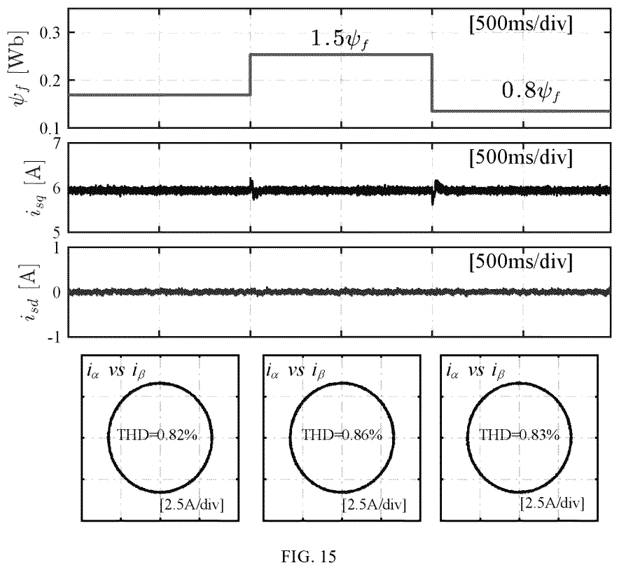

FIG. 13 shows d-axis and q-axis current waveforms of a permanent magnet synchronous motor under a working condition of 150 rad/s and 6 N·m when there is an inductance change. It can be clearly observed that when the d-axis and q-axis inductances are mismatched at the same time, the d-axis current of the system fluctuates obviously. However, thanks to the excellent disturbance suppression ability of the controller, this fluctuation can quickly attenuate and return to a steady state. In addition, it can be seen from analysis of the total harmonic distortion (THD) of current that the THD before and after the change of inductance parameters is basically the same, indicating that the system performance has not been significantly affected. Dynamic behaviors of the system under similar resistance and flux linkage mismatch are also verified in FIG. 14 and FIG. 15 respectively. These results comprehensively show that the designed EADRC can effectively resist the adverse effects caused by parameter changes under complex working conditions, and ensure the system has stronger anti-disturbance performance and reliability.

Therefore, compared with the ADRC and the IADRC, the EADRC shows stronger harmonic suppression ability and successfully solves the problem of unexpected peaks in the IADRC algorithm. In addition, the method also shows strong parameter robustness, and can still maintain excellent control performance under the change of system parameters.

In a word, the above are merely provided as preferred embodiments of this specification, but are not intended to limit the protection scope of this specification. Any modifications, equivalent replacements, improvements, and the like made within the spirit and principle of this specification shall fall within the protection scope of this specification.

The system, apparatus, module or unit set forth in one or more of the above embodiments can be implemented by a computer chip or an entity, or by a product with a certain function. A typical implementation device is a computer. Specifically, the computer can be, for example, a personal computer, a laptop computer, a cellular phone, a camera phone, a smart phone, a personal digital assistant, a media player, a navigation device, an email device, a game console, a tablet computer, a wearable device, or a combination of any of these devices.

It should be further noted that, the terms “comprise”, “include” or any other variations thereof intend to cover non-exclusive inclusion, so that the procedure, method, commodity, or means including a series of elements not only include those elements, but also include other elements that are not specifically listed, or also include inherent elements of this procedure, method, commodity, or means. An element defined by “includes a . . . ” does not, without more constraints, preclude the existence of additional identical elements in the process, method, commodity, or device that includes the element.

The embodiments of the present specification are described in a progressive manner. The same or similar parts of the embodiments can be referenced mutually. The focus of each embodiment is placed on a difference from other embodiments. Particularly, for a system embodiment, because it is basically similar to the method embodiment, the system embodiment is described briefly, and the relevant part may be obtained with reference to the description of the corresponding part in the method embodiment.

The foregoing has described specific embodiments of this specification. Other embodiments are within the scope of the appended claims. In some cases, actions or steps recited in the claims may be performed in a sequence different from that in the embodiments and still achieve desired results. In addition, the processes depicted in the drawings do not necessarily require the shown specific sequence or consecutive sequence to achieve the desired results. In some implementations, multitasking and parallel processing may be advantageous.

What is claimed is:

1. A current harmonic disturbance suppressing method of a permanent magnet synchronous motor, comprising:
constructing a current loop mathematical model of a permanent magnet synchronous motor considering total disturbance, and defining d-q axis total disturbance as an extended state of a motor system, wherein the current loop mathematical model of a permanent magnet synchronous motor considering total disturbance is as follows:
$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {i}_{sq} = {γ}_{0} {u}_{sq}^{*} + {f}_{sq 0} + {f}_{sq}^{t}\end{matrix} ;$$
wherein t represents time, i_{sd} represents a d-axis stator current, i_{sq} represents a q-axis stator current, γ₀ represents current control gain, γ₀=1/Lₛ₀, Lₛ₀ represents nominal inductance of a motor,
$${u}_{sd}^{*}$$
represents a d-axis stator reference voltage,
$${u}_{sq}^{*}$$
represents a q-axis stator reference voltage, f_{sd0} represents known d-axis disturbance, f_{sq0} represents known q-axis disturbance, f d represents d-axis total disturbance, and
$${f}_{sq}^{t}$$
represents q-axis total disturbance;
$${f}_{sd}^{t}$$
designing an improved resonant controller, wherein the improved resonant controller G_{IRSC}(s) for any frequency harmonic is as follows:
$${G}_{IRSC} ( s ) = \frac{{k}_{r} {ω}_{c} {Δ}_{1}}{{s}^{2} + 2 {ω}_{c} s + {ω}_{h}^{2}} ,$$
wherein kᵣ represents resonance gain, ω_{c} represents a resonance bandwidth, ωₕ represents a resonance frequency,
$${Δ}_{1} = {s}^{2} + 2 {ω}_{o} s + {ω}_{o}^{2} ,$$
s represents a Laplace complex frequency variable, and ωₒ represents a bandwidth of an extended state observer;
embedding the improved resonant controller into an extended state observer to estimate the total disturbance; and
introducing the total disturbance estimate into a control terminal as a feedforward signal, and designing a control law to compensate for the total disturbance in the current loop mathematical model of the permanent magnet synchronous motor.

2. The current harmonic disturbance suppressing method of a permanent magnet synchronous motor according to claim 1, wherein the total disturbance comprises aperiodic disturbance and periodic harmonic disturbance.

3. The current harmonic disturbance suppressing method of a permanent magnet synchronous motor according to claim 2, wherein a calculation equation of d-q axis periodic harmonic disturbance of the current loop is as follows:
f_{s_p}=N[Δuₕₐᵣ+nₚωₘψₕₐᵣ];
wherein f_{s_p}=[f_{sd_p} f_{sq_p}]^{T}, f_{s_p} represents the d-q axis harmonic disturbance, f_{sd_p} represents d-axis harmonic disturbance, f_{sq_p} represents q-axis harmonic disturbance,
$${Δ u}_{har} = [ \begin{matrix}{Δ u}_{d\_har} \\ {Δ u}_{q\_har}\end{matrix} ] ,$$
Δuₕₐᵣ represents d-q axis voltage harmonics caused by inverter dead-time effect, Δu_{d_har} represents d-axis voltage harmonics caused by inverter dead-time effect, Δu_{q_har} represents q-axis voltage harmonics caused by inverter dead-time effect,
$${ψ u}_{har} = [ \begin{matrix}{ψ}_{q\_har} \\ - {ψ}_{d\_har}\end{matrix} ] ,$$
ψₕₐᵣ represents d-q axis permanent magnet flux harmonics, ψ_{d_har} represents d-axis flux harmonics, ψ_{q_har} represents q-axis flux harmonics, N=[[1/(ΔL_{sd}+Lₛ₀) 0][0 1/(ΔL_{sq}+Lₛ₀)]]^{T}, nₚ represents the number of pole pairs of the motor, am represents a mechanical angular velocity of the motor, ΔL_{sd}=L_{sd}−L_{sd0}, ΔL_{sd} represents an error between d-axis actual inductance L_{sd} and nominal d-axis inductance L_{sd0}, ΔL_{sq}=L_{sq}−L_{sq0}, ΔL_{sq} represents an error between q-axis actual inductance L_{sq} and nominal q-axis inductance L_{sq0}, and a surface-mounted permanent magnet synchronous motor meets ΔL_{sd}=L_{sq0}=Lₛ₀; and
a calculation equation of d-q axis aperiodic disturbance of the current loop is as follows:
$$\{ \begin{matrix}{f}_{sd\_ap} = \frac{Δ {L}_{sd} {R}_{s 0} - {L}_{s 0} Δ {R}_{s}}{{L}_{s 0} ( Δ {L}_{sd} + {L}_{s 0} )} {i}_{sd} + \frac{{n}_{p} {ω}_{m} ( Δ {L}_{sq} - Δ {L}_{sd} )}{Δ {L}_{sd} + {L}_{s 0}} {i}_{sq} \\ - \frac{Δ {L}_{sd}}{{L}_{s 0} ( Δ {L}_{sd} + {L}_{s 0} )} {u}_{sd} + {δ}_{sd} \\ {f}_{{sq}_{-} a p} = \frac{Δ {L}_{sq} {R}_{s 0} - {L}_{s 0} {Δ R}_{s}}{{L}_{s 0} ( Δ {L}_{sq} + {L}_{s 0} )} {i}_{sq} - \frac{{n}_{p} {ω}_{m} ( Δ {L}_{sd} - Δ {L}_{sq} )}{Δ {L}_{sq} + {L}_{s 0}} {i}_{s d} \\ - \frac{Δ {L}_{sq}}{{L}_{s 0} ( Δ {L}_{sq} + {L}_{s 0} )} {u}_{sq} + \frac{- {L}_{s 0} Δ {ψ}_{f} + Δ {L}_{sq} {ψ}_{{f}_{0}}}{{L}_{s 0} ( Δ {L}_{sq} + {L}_{s 0} )} {n}_{p} {ω}_{m} + {δ}_{sq}\end{matrix} ;$$
wherein f_{sd_ap} represents d-axis aperiodic disturbance of the current loop, f_{sq_ap} represents q-axis aperiodic disturbance of the current loop, ΔRₛ=Rₛ−Rₛ_{₀}, ΔRₛ represents an error between actual resistance Rₛ and nominal resistance Rₛ_{₀}, Δψ_{f} represents an error between flux linkage of the motor ψ_{f} and nominal flux linkage ψ_{f0}, δ_{sd} represents d-axis uncertainty disturbance, and δ_{sd} represents q-axis uncertainty disturbance.

4. The current harmonic disturbance suppressing method of a permanent magnet synchronous motor according to claim 3, wherein defining the d-q axis total disturbance as the extended state of the motor system to obtain an extended state system is as follows:
$$\{ \begin{matrix}\frac{d}{dt} {i}_{sd} = {γ}_{0} {u}_{sd}^{*} + {f}_{sd 0} + {f}_{sd}^{t} \\ \frac{d}{dt} {f}_{sd}^{t} = {𝒩}_{sd}\end{matrix} ;$$
$$\{ \begin{matrix}\frac{d}{dt} {i}_{sq} = {γ}_{0} {u}_{sq}^{*} + {f}_{sq 0} + {f}_{sq}^{t} \\ \frac{d}{dt} {f}_{sq}^{t} = {𝒩}_{sq}\end{matrix} ;$$
wherein [symbol] _{sd} is a derivative of the d-axis total disturbance, and [symbol] _{sq} is a derivative of the q-axis total disturbance.

5. The current harmonic disturbance suppressing method of a permanent magnet synchronous motor according to claim 3, wherein when suppressing multi-frequency harmonic disturbance, an expression of the improved resonant controller G_{IRSC}_{ₛ}(s) is as follows:
$${G}_{{IRSC}_{S}} ( s ) = \frac{{k}_{r 1} {ω}_{c 1} {Δ}_{1}}{{s}^{2} + 2 {ω}_{c 1} s + {ω}_{h 1}^{2}} + \frac{{k}_{r 2} {ω}_{c 2} {Δ}_{1}}{{s}^{2} + 2 {ω}_{c 2} s + {ω}_{h 2}^{2}} + … + \frac{{k}_{rn} {ω}_{cn} {Δ}_{1}}{{s}^{2} + 2 {ω}_{cn} s + {ω}_{hn}^{2}}$$
wherein kᵣ₁, kᵣ₂, . . . , kᵣₙ represent resonance gains of different frequencies, ω_{c1}, ω_{c2}, . . . , ω_{cn} represent resonance bandwidths of different frequencies, and ωₕ₁, ωₕ₂, . . . , ωₕₙ represent resonance frequencies of different frequencies.

6. The current harmonic disturbance suppressing method of a permanent magnet synchronous motor according to claim 5, wherein when 6th harmonic disturbance and 12th harmonic disturbance are suppressed, ωₕ₁=6nₚωₘ, ωₕ₂=12nₚωₘ.

7. The current harmonic disturbance suppressing method of a permanent magnet synchronous motor according to claim 6, wherein embedding the improved resonant controller into the extended state observer, improved d-axis and q-axis resonant—extended state observers are obtained as follows:
$$\{ \begin{matrix}\frac{d}{dt} {î}_{sd} = {γ}_{0} {u}_{sd}^{*} + {f}_{sd 0} + {\hat{f}}_{sd}^{c} + {λ}_{1} ( {i}_{sd} - {î}_{sd} ) \\ {\hat{f}}_{sd}^{c} = {\hat{f}}_{{sd}_{-} ap}^{t} + {\hat{f}}_{{sd}_{-} p}^{t} , {\hat{f}}_{{sd}_{-} p}^{c} = {κ}_{2} + {κ}_{4} \\ {ϑ}_{sd} = ( {i}_{sd} - {î}_{sd} ) + \frac{d}{dt} ( {i}_{sd} - {î}_{sd} ) + \int ( {i}_{sd} - {î}_{sd} ) dt \\ \frac{d}{dt} {κ}_{1} = {κ}_{2} , \frac{d}{dt} {κ}_{3} = {κ}_{4} \\ \frac{d}{dt} {κ}_{2} = - {ω}_{h 1}^{2} {κ}_{1} + {λ}_{2} {k}_{r 1} {ω}_{c 1} {ϑ}_{sd} - 2 {ω}_{c 1} {κ}_{2} \\ \frac{d}{dt} {\hat{f}}_{{sd}_{-} ap} = {λ}_{2} ( {i}_{sd} - {î}_{sd} ) \\ \frac{d}{dt} {κ}_{4} = - {ω}_{h 2}^{2} {κ}_{3} + {λ}_{2} {k}_{r 2} {ω}_{c 2} {ϑ}_{sd} - 2 {ω}_{c 2} {κ}_{4}\end{matrix} ;$$
$$\{ \begin{matrix}\frac{d}{dt} {î}_{sq} = {γ}_{0} {u}_{sq}^{*} + {f}_{sd 0} + {\hat{f}}_{sq}^{c} + {λ}_{1} ( {i}_{sq} - {î}_{sq} ) \\ {\hat{f}}_{sq}^{c} = {\hat{f}}_{{sq}_{-} ap}^{t} + {\hat{f}}_{{sq}_{-} p}^{t} , {\hat{f}}_{{sq}_{-} p}^{c} = {κ}_{2} + {κ}_{4} \\ {ϑ}_{sq} = ( {i}_{sq} - {î}_{sq} ) + \frac{d}{dt} ( {i}_{sq} - {î}_{sq} ) + \int ( {i}_{sq} - {î}_{sq} ) dt \\ \frac{d}{dt} {κ}_{1} = {κ}_{2} , \frac{d}{dt} {κ}_{3} = {κ}_{4} \\ \frac{d}{dt} {κ}_{2} = - {ω}_{h 1}^{2} {κ}_{1} + {λ}_{2} {k}_{r 1} {ω}_{c 1} {ϑ}_{sq} - 2 {ω}_{c 1} {κ}_{2} \\ \frac{d}{dt} {\hat{f}}_{{sq}_{-} ap} = {λ}_{2} ( {i}_{sq} - {î}_{sq} ) \\ \frac{d}{dt} {κ}_{4} = - {ω}_{h 2}^{2} {κ}_{3} + {λ}_{2} {k}_{r 2} {ω}_{c 2} {ϑ}_{sq} - 2 {ω}_{c 2} {κ}_{4}\end{matrix} ;$$
wherein \hat{l}_{sd} represents a d-axis stator current estimate, \hat{l}_{sq} represents a q-axis stator current estimate,
$${\hat{f}}_{sd}^{t}$$
represents a d-axis total disturbance estimate,
$${\hat{f}}_{sq}^{t}$$
represents a q-axis total disturbance estimate,
$${\hat{f}}_{sd \_ ap}^{t}$$
represents a d-axis aperiodic disturbance estimate,
$${\hat{f}}_{sq \_ ap}^{t}$$
represents a q-axis aperiodic disturbance estimate,
$${\hat{f}}_{sd \_ p}^{t}$$
represents a d-axis harmonic disturbance estimate,
$${\hat{f}}_{sq \_ p}^{t}$$
represents a q-axis harmonic disturbance estimate, κ₁, κ₂, κ₃, and κ₄ represent state variables of the improved resonant controller, λ₁ and λ₂ represent gain coefficients of the extended state observer, and ϑ_{sd} and ϑ_{sq} represent intermediate variables.

8. The current harmonic disturbance suppressing method of a permanent magnet synchronous motor according to claim 7, wherein the control law is as follows:
$$\{ \begin{matrix}{u}_{sd}^{*} = \frac{{i}_{sd}^{*} + {u}_{d 0} - {f}_{sd 0} - {\hat{f}}_{sd}^{t}}{{γ}_{0}} \\ {u}_{sq}^{*} = \frac{{i}_{sq}^{*} + {u}_{q 0} - {f}_{sq 0} - {f}_{sq}^{t}}{{γ}_{0}}\end{matrix} ;$$
wherein
$${u}_{sd}^{*}$$
represents the d-axis stator reference voltage,
$${u}_{sq}^{*}$$
represents the q-axis stator reference voltage,
$${i}_{sd}^{*}$$
represents a d-axis reference current,
$${i}_{sq}^{*}$$
represents a q-axis reference current, f_{sd0} represents a constant for compensating for the known d-axis disturbance, f_{sq0} represents a constant for compensating for the known q-axis disturbance,
$${u}_{d 0} = {k}_{pd} ( {i}_{sd}^{*} - {\hat{l}}_{sd} ) ,$$
k_{pd} represents d-axis current loop controller gain,
$${u}_{q 0} = {k}_{pq} ( {i}_{sq}^{*} - {\hat{l}}_{sq} ) ,$$
and k_{pq} represents q-axis current loop controller gain.

9. A motor system, adopting the current harmonic disturbance suppressing method of a permanent magnet synchronous motor according to claim 1.
